(19) United States
(12) Patent Application Publication
(10) Pub. No.: US 2007/0087696 A1
(43) Pub. Date: Apr. 19, 2007

(54) System and method for using an ad hoc surrogate device for reporting a service adnormality

(76) Inventors: Jeffrey D. Bonta, Arlington Heights, IL (US); Benedito J. Fonseca JR., Lombard, IL (US); Avinash Joshi, Orlando, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/251,717

(22) Filed: Oct. 17, 2005

(51) Int. Cl. H04B 17/00

(52) U.S. Cl. 455/67.11

(57) ABSTRACT

A system and method for using an ad hoc surrogate device (103, 103′) for reporting a service abnormality where the surrogate mobile device operates on a second communications system, such as a cellular telephone system, to collect and deliver diagnostic or other service abnormality information from a first communications system using Bluetooth, WiFi or the like. Any device utilizing Bluetooth or WiFi can be modified to fulfill the need for reporting service problems without the use of telemetry or other continuous monitoring systems.

### FIELD OF THE INVENTION

The present invention relates generally to a surrogate mobile device operating on a second communications system to collect and deliver diagnostic information transmitted from a first communications system.

### BACKGROUND

Today, we depend on many electronic and mechanical devices to provide numerous services beneficial to the public. These devices can range from complicated computer systems for operating public service facilities, cellular telephone base sites for providing communications, street lights for providing illumination for public use, vending machines, etc. When devices used to operate such systems become inoperative due to functional failures, lack of operational resources, equipment damage, or illegitimate use, those relying on these devices can become inconvenienced and much less productive. In the case of cellular or other wireless communications systems, there may be geographic areas providing inadequate wireless coverage or situations where users cannot sustain communication due to poor service quality (e.g., low data rate). These types of problems can cause loss of productivity for users of the system and loss of revenue for the wireless network carrier.

Since lost productivity can translate to lost revenue, it becomes essential that faulty or inoperative equipment be identified and repaired as quickly as possible. Reporting faulty equipment can be even more problematic if the device is in a fixed position or has become immobilized. Since the device cannot move and may not be continually monitored, its defective status may not be quickly recognized. Consequently, a problem arises in reporting these inoperative devices or systems to their service providers.

Telemetering is a well-known technique in the art, where a device may be continually monitored to determine its operational status. Using telemetry to continually monitor systems having a large number of devices can be expensive and impractical. As an alternative, several prior art systems have been developed where recorded information can be reported through secondary communications systems. For example, U.S. Patent Publication No. US 2005/0134683 discloses a wearable computer where a camera collects data for an on-board computer having a wireless interface. When a user moves into a location that has wireless connectivity, data can then be transferred from the camera. The problem with this type of system is that the user must physically move into an area having connectivity. If the camera cannot be moved to communicate with the receiving network, data cannot be transferred. Similarly, U.S. Patent Publication No. US 2005/0136972 illustrates a plug-in appliance which acts as a bridge for transferring data between two different wireless interfaces. Similar to a camera-type system, the problem with this network appliance is that the wireless bridge is plugged into a fixed, immobile infrastructure. Thus, these prior art systems use an integrated communications system to report problems with their own environment but cannot use surrogate mobile devices to report and/or deliver diagnostic information.

Similarly, some systems rely on an integrated radio transceiver to communicate the failure at the time of failure. For example, the General Motors OnStar system provides the ability to detect and report inoperative conditions in an automobile. However, the OnStar system depends entirely on an integrated cellular telephone to communicate the problem with a service center. Even the OnStar system would fail if the dedicated cellular device failed or if the automobile were located in an area with no cellular service. Other attempts to solve this problem only make an effort to diagnose inoperable conditions within the domain of a single communication system. For example, some cellular mobile devices can collect operational metrics concerning the cellular system where they are operated. However, these devices cannot communicate the metrics by any other means other than through their primary cellular network

In addition, U.S. Pat. No. 6,580,981 entitled “System and Method for Providing Wireless Telematics Store and Forward Messaging for Peer-To-Peer and Peer-To-Peer-To-Infrastructure A Communication Network” which is herein incorporated by reference, provides for a mobile device having a host computer which sends status and request-for-help messages automatically to an appropriate destination via a wireless infrastructure. When such infrastructure is not available, the host computer and transceiver of the mobile device will communicate the necessary information via a passing vehicle equipped with a like transceiver and mobile host. The information is stored in the transceiver of the passing vehicle and transmitted from that vehicle through the infrastructure once it is within range of the second vehicle. A disadvantage with this approach is that the host computer of the mobile device only has one transceiver for communicating with the infrastructure and the passing vehicle. Such an architectural solution would limit the choice of host computer and transceiver candidates for storing and forwarding the information to only those with a like transceiver. For example, this would eliminate cellular handsets as candidate hosts since cellular handsets cannot communicate directly with each other over a cellular channel.

Finally, since it is impractical to continually monitor every device or every region utilizing an electronic device which provides service to the public, there is a need to inform an owner, service provider, or caretaker of the operational state of the device which requires maintenance. Similarly, there is a need for a system and method that works to notify the service provider, enabling it to find inoperable devices or regions of poor quality service without necessitating telemetry for these devices. These devices might include poorly performing wireless systems, traffic or public lighting, vending machines, and the like. Since there are many devices that need to express their inoperative status without depending on a single dedicated wired or wireless connection, the need for this technology is self-evident.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating overall operation of the system for using an ad hoc surrogate device for reporting a service abnormality in accordance with an embodiment of the invention.

FIG. 2 is a block diagram illustrating an ad hoc communications device operable on both a first communications network and second communications network in accordance with an embodiment of the invention.

FIG. 3 is a flow chart illustrating steps used by an inoperative or malfunctioning device at a first communications system to report an abnormality in accordance with a method of the invention.

FIG. 4 is a flow chart illustrating steps at a second communications system, such as a cellular base site, for reporting data received from an inoperative device in accordance with a method of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a surrogate mobile device operating on a second communication system to collect and deliver diagnostic information from a first communication system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a surrogate mobile device operating on a second communication system to collect and deliver diagnostic information from a first communication system described herein. The non-processor circuits may include, but are not limited to, a radio receiver, a radio transmitter, signal drivers, clock circuits, power source circuits, and user input devices. As such, these functions may be interpreted as steps of a method where a surrogate mobile device operating on a second communication system collects and delivers diagnostic information from a first communication system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

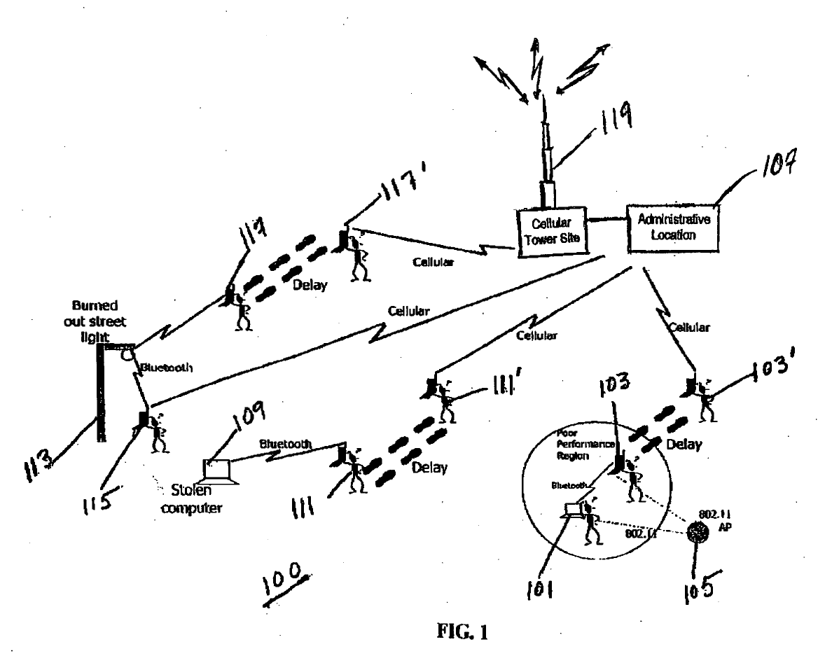

With regard to FIG. 1, an advantage of the invention is that it utilizes a mobile device that operates on a second communication system such as cellular communications network to communicate problems or abnormalities associated with a first communication system to a service center. Although the Institute of Electrical and Electronics Engineeers (IEEE) standard 802.11 wireless fidelity (WiFi) hub is referred to by way of example, it should be evident to those skilled in the art that other standards may be used as well including, but not limited to, Bluetooth, IEEE 802.15, or IEEE 802.16. The term “WiFi” as used herein generally refers to these standards.

Referring now to FIG. 1, an ad hoc reporting communications system 100 includes a personal computer 101 or the like which has limited mobility and is located in a region near the service range of a WiFi hub 105. In some exemplary situations, the personal computer 101 may be operating improperly or at less than its optimal performance. When such operational faults occur, the personal computer 101 may not be able to report its own performance abnormality for its current location. The performance abnormality may be detected based upon, for example, the current data rate received by the personal computer 101 and a service map guaranteed by the service provider of WiFi hub 105. When personal computer 101 identifies its location as determined by an internal global positioning system (GPS) location receiver and measures a quality of service (QOS) at a current location as being below a minimum service quality threshold, it will report this performance abnormality. Rather than wait for the performance abnormality to be detected by the service provider by chance, the personal computer 101 has the ability to report the disruption to an ad hoc device 103, such as a cellular telephone handset or the like, operating either on the same or an alternative communications system. As noted herein, the performance abnormality can be reported through an ad hoc communications link, such as Bluetooth link or WiFi link that is in range of the personal computer 101. At some later time, the ad hoc device 103′ will have the ability to convey an error message, disruption message or other reporting data to an administrative location 107 via a second communication system, such as a cellular communications network 119. This later point in time may not occur until after the ad hoc device 103′ has moved within range of the cellular communications network 119 to enable a transfer of the reporting data to an administration location 107. The administrative location 107, for example, may be a service center that provides a graphical tool showing the location of various infrastructure devices that are providing coverage, or various landmarks on a street map to correlate with the reported service disruption. Based on the received data identifying inoperable equipment, the tool may then show the current position of the inoperative service or inoperable device as communicated by the ad hoc device 103.

In another embodiment, a device such as a stolen computer 109 can report the theft to an ad hoc device 111 at some later time when the ad hoc device 111′ is in range of the cellular network 119, thus enabling a transfer of the reporting data to an administrative location 107. The stolen computer 109 may use a GPS receiver to detect that its current location is out of a pre-programmed range of locations. Alternatively, the stolen computer 109 may detect that it is no longer within range of a particular WiFi hub. Similarly, a device such as an inoperative street lamp 113 can report its inoperative status through a Bluetooth or WiFi link to an ad hoc device 115. The ad hoc device 115, such as a cellular telephone handset, can directly report the abnormality to the administrative location 107. Alternatively, it can be reported to an ad hoc device 117 through a Bluetooth link or the like where the ad hoc device 117′ will report the abnormality via a cellular network 119 connection to an administrative location 107 at some later time.

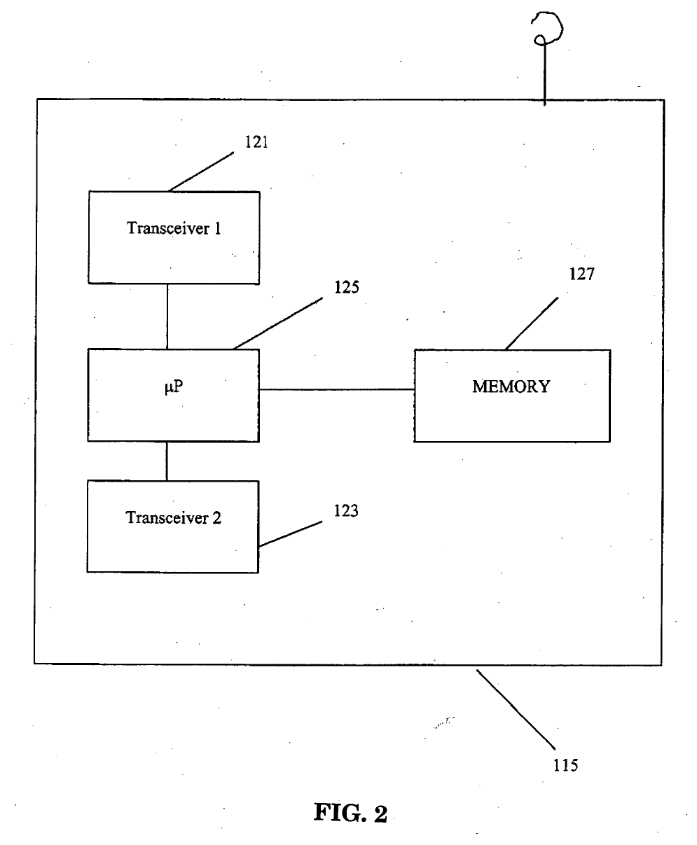

FIG. 2 illustrates the ad hoc communications device 115 that includes a first transceiver 121 and second transceiver 123. As noted herein, the first transceiver 121 communicates with other communications device in a wideband communications mode such a cellular telephone communications or the like. The second communications transceiver 123 is used to communicate with the device having the performance abnormality typically using a Bluetooth or WiFi protocol. In operation, the communications regarding the performance abnormality is stored in memory 125 where a microprocessor 127 or other control device operates the ad hoc communications device so to store the message until it can be transmitted at some later time by the first transceiver 121.

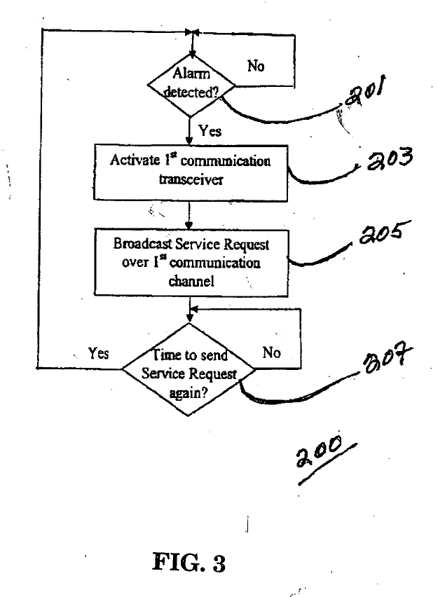

FIG. 3 is a flow chart illustrating a method as used by a device having an inoperative condition within, for example, the system of FIG. 1. The method 200 as used by the device uses ad hoc surrogate devices for detecting and reporting a service disruption. The method first determines if an alarm has been detected 201. The alarm, for example, may be an indication of a portion of the device that has become inoperable, or it may be a low QOS indication. Such an alarm may be generated when the monitoring device measures abnormal performance such as a minimal QOS threshold being crossed, a continuity signal being compromised, or the like. When the alarm is detected, then an ad hoc communications transceiver is activated 203. As noted herein, the ad hoc communications transceiver may utilize Bluetooth, WiFi, or a wide band communications protocol. The service request is then broadcast 205 over the ad hoc communications channel where it can be received by an ad hoc surrogate device for reporting the service problem. If the message is not received by the surrogate device within some predetermined time period, then it may be retransmitted 207 after a time period timeout and the method begins again 201.

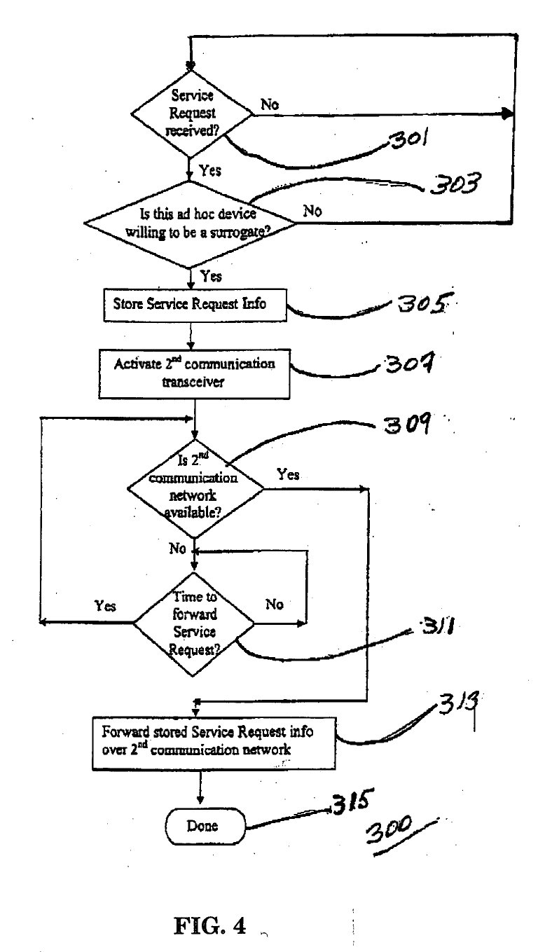

FIG. 4 illustrates a flow chart of the method 300 used by a surrogate device within, for example, the system of FIG. 1. If a service request is received 301, a determination is made whether the ad hoc device is capable and/or willing 303 to be a surrogate device in order to deliver the service message. If not, the surrogate device returns 301 to wait for a new service request. If it is willing to be the ad hoc surrogate, the service request information and/or data are stored 305 within the surrogate device. A second communications transceiver is then activated also within the surrogate device. Since the first communications transceiver was an ad hoc communication device, the secondary communications transceiver is typically a cellular communication or other type of primary radio communication or the like. It will be appreciated by those of ordinary skill in the art, however, that any communication system can be utilized for the second communication system including a second ad hoc network. If the second communications network is available 309 the stored service request is forwarded 313 over the second communications network for delivery to an administrative device or service center where the process is completed 315. If the second communications network is not available, then a timer is set 311 for checking the availability of the second communications network. When available, the stored service request is then forwarded 313 and the method completed 315. Those skilled in the art will recognize that the flow chart may optionally loop back to the start to capture new service request. Additionally, the Service Request contains relevant information such as alarming device identification (ID), alarm specific data, billing information, location data and/or time of failure, etc. It will be appreciated that the actual communication protocol used between the inoperable device, the ad hoc surrogate, and the administrative location can vary.

Thus, the invention operates with either a mobile or stationary device that desires to communicate some message reporting its inoperative condition to an administrative location or other type of service center. The device can utilize a low-power transceiver (not shown) using an alternative communications system such as a Bluetooth, WiFi type protocols or a wideband area communications network to search for and locate a transceiver having a dual-mode capability. The dual-mode mobile communications transceiver such as a cellular telephone or the like is willing to be a surrogate to carry the message to a service center for communicating inoperative status information using a second communications system such as a cellular system. Once a willing mobile transceiver is located to act as a surrogate, the stationary device will transmit the message containing the desired information to the mobile device for later transmission to a service center. The mobile device may be one of many such devices capable of being a surrogate and is unknown to the stationary device prior to the search and locate operation. The mobile surrogate device can immediately communicate the message to the service center if it is within communication range, or it may store the message and forward it to the service center when it comes within communication range. Alternatively, a number of dual-mode mobile transceivers may detect a region of inoperability (poor coverage or low service quality) on a first communication system (e.g., IEEE 802.11) and transfer this information to a service center via a second communication (e.g., cellular).

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the tendency of this application and all equivalents of those claims as issued.

What is claimed is:

1. A communications system for reporting a service disruption comprising:
a first communications device for transmitting a service abnormality communication via a first communications system;
a second communications device for receiving the service abnormality communication and transmitting the service abnormality communications via a second communications system; and
wherein the second communications device acts as an ad hoc surrogate for reporting the abnormality data to a predetermined location.

2. A communications system for reporting a service disruption as in claim 1, wherein the first communications system operates using a Bluetooth communication.

3. A communications system for reporting a service disruption as in claim 1, wherein the first communications system operates using a WiFi communication.

4. A communications system for reporting a service disruption as in claim 1, wherein the second communications system is a cellular telephone network.

5. A communications system for reporting a service disruption as in claim 1, wherein the second communications device stores the service abnormality communication until it can complete the transmission via the second communications system.

6. A communications system for reporting a service disruption as in claim 1, wherein the second communications device includes a first transceiver for transmitting on the first communications network, a second transceiver for transmitting on the second communications network.

7. A communications system for reporting a service disruption as in claim 1, wherein the second communications device includes a memory for storing the service abnormality communication for transmission on the second communications network.

8. A method for using an ad hoc surrogate device for reporting a service disruption comprising the steps of:
transmitting a service abnormality communication from a first communications device on a first communications system;
receiving the service abnormality communication at a second communications device; and
transmitting the service abnormality communication from the second communications device to a predetermined location on a second communications system.

9. A method for using an ad hoc surrogate device as in claim 8, wherein the service abnormality communication is transmitted via a Bluetooth link.

10. A method for using an ad hoc surrogate device as in claim 8, wherein the service abnormality communication is transmitted using a WiFi link.

11. A method for using an ad hoc surrogate device as in claim 8, wherein the second communications system is a cellular telephone system.

12. A method for using an ad hoc surrogate device as in claim 8, further including the step of:
storing the service abnormality communication at the second communications device until establishing communication with the second communications system.

13. A method for using an ad hoc surrogate device as in claim 8, wherein the second communications device includes a first transceiver for transmitting on the first communications system, a second transceiver for transmitting on the second communications system and at least one memory for storing the service abnormality communication.

14. A system for using an ad hoc surrogate device for reporting a service abnormality comprising:
a first communications device in a fixed position for sending a diagnostic communication on a first communications system;
a second communications device capable of mobile operation for receiving the diagnostic communication and operating on a cellular telephone network; and
wherein the second communications device transmits the diagnostic communication when in communication with the cellular telephone network.

15. A system for using an ad hoc surrogate device as in claim 14, wherein the first communications system uses a Bluetooth protocol.

16. A system for using an ad hoc surrogate device as in claim 14, wherein the first communications system uses an IEEE 802.11 protocol.

17. A system for using an ad hoc surrogate device as in claim 14, wherein the first communications device is at least one from the group of street lamp, vending machine, or personal computer.

18. A system for using an ad hoc surrogate device as in claim 14, wherein the first communications device stores the diagnostic communication until it can be transmitted to a service location.

19. A system for using an ad hoc surrogate device as in claim 14, wherein the second communicates device includes a first transceiver for communicating on the first communications system and a second communications device for communications system.

20. A system for using an ad hoc surrogate device as in claim 19, wherein the second communications device includes a memory for storing diagnostic communication until it is transmitted on the second communications system.
